(19) United States
(12) Patent Application Publication
(10) Pub. No.: US 2011/0249609 A1
(43) Pub. Date: Oct. 13, 2011

(54) Secure Relay Node in Communication System

(76) Inventors: Alec Brusilovsky, Naperville, IL (US); Violeta Cakulev, Milburn, NJ (US)

(21) Appl. No.: 12/756,716

(22) Filed: Apr. 8, 2010

(51) Int. Cl. H04B 7/14

(52) U.S. Cl. 370/315

(57) ABSTRACT

Techniques are disclosed for use in securing communications in environments such as those employing relay nodes. For example, in a communication network wherein a first computing device comprises a user node, a second computing device comprises a relay node, and a third computing device comprises a network access node, and wherein the relay node comprises: a first module for connecting the user node to the communication network; and a second module for connecting the relay node to the network access node, a method comprises the following steps. At least one packet is received at the first module of the relay node from the user node over an interface established between the user node and the relay node. At least one packet is sent from the first module of the relay node to the second module of the relay node via a secure channel established by the first module in accordance with a secure communication protocol. The at least one packet is sent from the second module of the relay node to the network access node via the secure channel and over an interface established between the relay node and the network access node.

### FIELD OF THE INVENTION

The present invention relates generally to communication security and, more particularly, to a protocol for use in securing communications in environments such as those employing relay nodes.

### BACKGROUND OF THE INVENTION

Relay nodes in a communication system are nodes that are used to relay traffic (e.g., data, voice, multimedia; depending on the type of network(s) being employed) from one or more nodes in a network to one or more other nodes in the same or other network. Relay nodes are known to be used in 3GPP (3rd Generation Partnership Project) networks.

As is known, 3GPP develops and maintains Technical Specifications (TSs) and Technical Reports (TRs) specifying networks such as the 3G Mobile System based on evolved Global Systems Mobile (GSM) core networks and the radio access technologies that they support, i.e., UMTS Terrestrial Radio Access (UTRA) both Frequency Division Duplex (FDD) and Time Division Duplex (TDD) modes. Note that UMTS stands for Universal Mobile Telecommunications System. In addition, 3GPP also develops and maintains TSs and TRs that specify evolved radio access technologies, e.g., General Packet Radio Service (GPRS) and Enhanced Data rates for GSM Evolution (EDGE). Further, the Long Term Evolution (LTE) network is a 3GPP-specified network that aims to improve the UMTS mobile phone standard and provide an enhanced user experience and simplified technology for next generation mobile broadband.

Still further, LTE radio access technology is known as Evolved UMTS Terrestrial Radio Access (E-UTRA) and the network is known as an Evolved Packet System (EPS). Details about E-UTRA may be found in 3GPP TR 36.912 and relay architectures for E-UTRA may be found in 3GPP TR 36.806, the disclosures of which are incorporated herein by reference in their entirety. However, there currently is no security architecture for relay nodes in such 3GPP network.

### SUMMARY OF THE INVENTION

Principles of the invention provide techniques for use in securing communications in environments such as those employing relay nodes.

For example, in one aspect of the invention, in a communication network wherein a first computing device comprises a user node, a second computing device comprises a relay node, and a third computing device comprises a network access node, and wherein the relay node comprises: a first module for connecting the user node to the communication network; and a second module for connecting the relay node to the network access node, a method comprises the following steps. At least one packet is received at the first module of the relay node from the user node over an interface established between the user node and the relay node. At least one packet is sent from the first module of the relay node to the second module of the relay node via a secure channel established by the first module in accordance with a secure communication protocol. At least one packet is sent from the second module of the relay node to the network access node via the secure channel and over an interface established between the relay node and the network access node.

At least one packet sent from the first module of the relay node may comprise backhaul traffic. The backhaul traffic may comprise at least one of: one or more data packets from the user node; and one or more control packets from the relay node.

The first module of the relay node maybe coupled to the second module of the relay node via a local area network interface, e.g., an Ethernet interface.

The interface established between the user node and the relay node may be a first wireless communication interface, and the interface established between the relay node and the network access node may be a second wireless communication interface such that, in one embodiment, the first wireless communication interface is different than the second wireless communication interface, while in another embodiment, the first wireless communication interface is the same as the second wireless communication interface.

In one embodiment, the communication network utilizes an Evolved UMTS Terrestrial Radio Access (E-UTRA) technology. In such case, the user node is a UE node, the network access node is a Donor eNodeB node, the first module of the relay node is a Home eNodeB node, and the second module of the relay node is a UE node. In a UTRA embodiment, the network access node is a Donor NodeB node and the first module of the relay node is a Home NodeB node. Furthermore, the secure channel established by the first module in accordance with the secure communication protocol may comprise an Internet Protocol secure tunnel.

In another aspect of the invention, a relay node comprises: a first module for connecting a user node to a communication network; and a second module for connecting the relay node to a network access node of the communication network. The relay node: receives at least one packet at the first module from the user node over an interface established between the user node and the relay node; sends at least one packet from the first module to the second module via a secure channel established by the first module in accordance with a secure communication protocol; and sends the at least one packet from the second module to the network access node via the secure channel and over an interface established between the relay node and the network access node.

In yet another aspect of the invention, apparatus comprises: a memory; and at least one processor coupled to the memory and configured to form a relay node comprising a first module for connecting a user node to a communication network; and a second module for connecting the relay node to a network access node of the communication network, wherein the relay node: receives at least one packet at the first module from the user node over an interface established between the user node and the relay node; sends at least one packet from the first module to the second module via a secure channel established by the first module in accordance with a secure communication protocol; and sends the at least one packet from the second module to the network access node via the secure channel and over an interface established between the relay node and the network access node.

In a further aspect of the invention, in a communication network wherein a first computing device comprises a user node, a second computing device comprises a relay node, and a third computing device comprises a network access node, and wherein the relay node comprises: a first module for connecting the user node to the communication network; and a second module for connecting the relay node to the network access node, a method comprises the following steps. At least one packet is transmitted between the first module of the relay node and the second module of the relay node via a secure channel established by the first module in accordance with a secure communication protocol. The at least one packet is transmitted between the second module of the relay node and the network access node via the secure channel and over an interface established between the relay node and the network access node.

Advantageously, the relay node architecture and methodologies of the invention significantly reduce complexities related to integrity and replay protection of the backhaul traffic for relay nodes, and provide network operators with improved flexibility with respect to network deployment.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an E-UTRA network according to an embodiment of the invention.

FIG. 2 illustrates an E-UTRA network according to another embodiment of the invention.

FIG. 3 illustrates functional network entities/elements associated with a hybrid relay node architecture according to an embodiment of the invention.

FIG. 4 illustrates protected traffic flow associated with a hybrid relay node architecture according to an embodiment of the invention

FIG. 5 illustrates a protocol for an initial network attach of a user device connecting via a relay node according to an embodiment of the invention.

FIG. 6 illustrates a hardware architecture of a part of a communication system and computing devices suitable for implementing one or more of the methodologies and protocols according to embodiments of the invention.

### DETAILED DESCRIPTION OF PREFERRED EMBODIMENTS

Principles of the present invention realize the need to secure communications associated with a relay node in a communication system. In the embodiments to follow, an E-UTRA network will be used to illustratively describe the security techniques and mechanisms of the invention. However, it is to be understood that the principles of the present invention are not limited to an E-UTRA network and are suitable for a wide variety of other networks in which relay nodes may be employed.

In particular, with respect to relay nodes in an E-UTRA network, illustrative principles of the present invention realize the need for integrity and replay protection for communications over backhaul communication links associated with a relay node.

As is known, backhaul typically refers to the portion of the network that comprises intermediate links between the core network, or backbone, of the network and the small subnetworks at the edge of the entire network. For example, while cell phones communicating with a base station constitute a local subnetwork (or radio-access network, or UTRAN/E-UTRAN, depending on the access technology), the connection between the cell tower and the core network begins with a backhaul link to the core of a PLMN (Public Land Mobile Network). For instance, in a typical E-UTRA network, backhaul may refer to the one or more communication links between Home eNodeB (HeNB) nodes and nodes in the operator's core network, i.e., MME (Mobile Management Entity), SGW (Serving Gateway), PGW (Packet Data Network Gateway).

In a E-UTRA network embodiment of the present invention, backhaul is considered to also include the one or more communication links associated with a relay node (RN) and one or more eNodeB (eNB) nodes of the operator's core network with which the RN communicates, as will be illustrated in detail below. Also, this part of the backhaul may be more specifically referred to as the RN backhaul.

As is known, eNBs serve as base stations for the user equipment (UE) nodes to access a PLMNs. A UE (also referred to as a mobile station or MS when functioning as an end-user communication device) is composed of Mobile Equipment (ME) and UMTS Subscriber Identity Module (USIM). Examples of mobile station or user equipment may include but are not limited to a mobile telephone, a portable computer, a wireless email device, a personal digital assistant (PDA) or some other user mobile communication device.

In accordance with an embodiment of the invention, an RN may have a similar architecture (i.e., transmit and receive circuitry, and processing and memory circuitry) as an eNB since it serves as an access point for the UE to the network under certain circumstances and conditions, examples of which will be described below. It is to be understood that the term “node” as used herein refers to one or more components or one or more devices (including but not limited to communication devices and computing devices) that may be employed by or associated with one or more networks of a communication system.

“Integrity protection” (IP) refers to protecting the integrity of messages (data) transmitted over the RN backhaul so that attackers can not intercept and forge transmitted messages. “Replay protection” (RP) refers to protecting against attackers being able to replay messages previously transmitted over the RN backhaul.

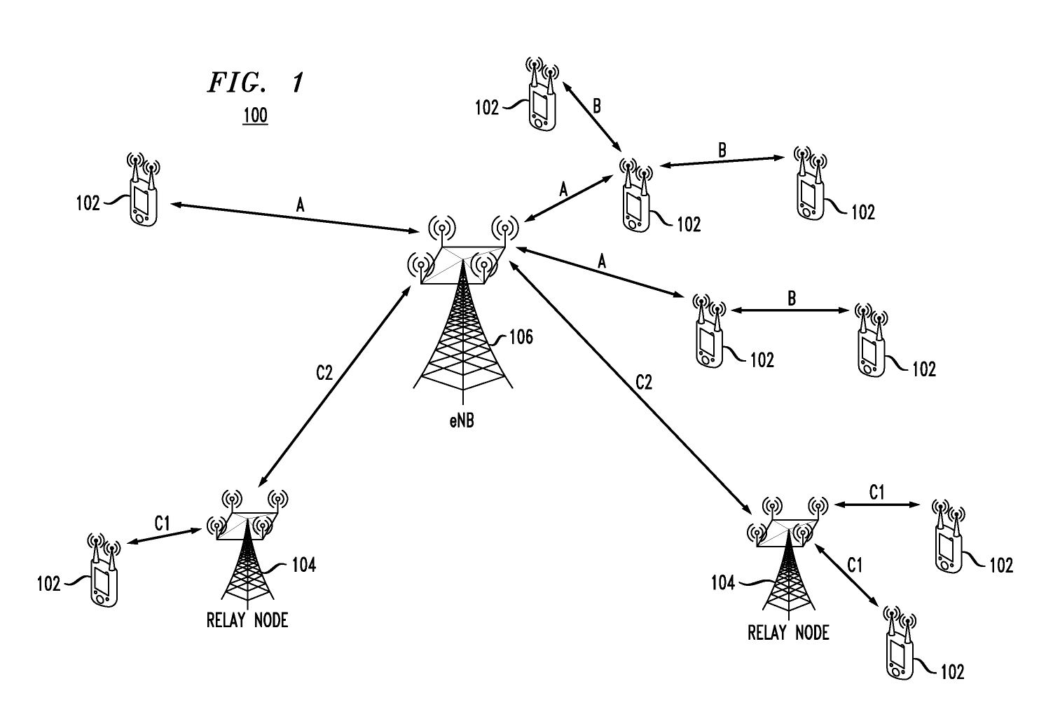

Referring now to FIG. 1, an E-UTRA network 100 according to an embodiment of the invention is shown. It is to be understood that while the network 100 is depicted as comprising a plurality of UEs 102, a plurality of RNs 104, and an eNB 106, more or less nodes (e.g., network components and/or devices) may comprise the network.

As depicted in the network 100, there are three types of data transmission between eNBs and UEs. They are depicted in FIG. 1 as type A, type B and type C (C1 and C2). Note that it is assumed, in this illustrative embodiment, that each type of data transmission shown is comprised of wireless link connections. However, other forms of links other than wireless may be employed.

First, type A data transmission is typical transmit/receive (e.g., single hop Tx/Rx) communication between a UE 102 and eNB 106. Second, type B is referred to as UE relaying which comprises direct inter-UE connectivity. This type of communication is typically handled by autonomous ad-hoc inter-UE network configuration and management, and is usually considered to be an unmanaged spectrum, e.g., Bluetooth. This type of transmission may also be used to support emergency call features. Third, type C transmission is related to relay node transmit/receive communication. As shown, the type of transmission for the RN is further depicted as C1 and C2, where C1 depicts communication between a UE 102 and an RN 104 and C2 depicts communication between an RN 104 and eNB 106. It is the C2 type communication, or RN backhaul communication, to which illustrative principles of the invention are preferably applied.

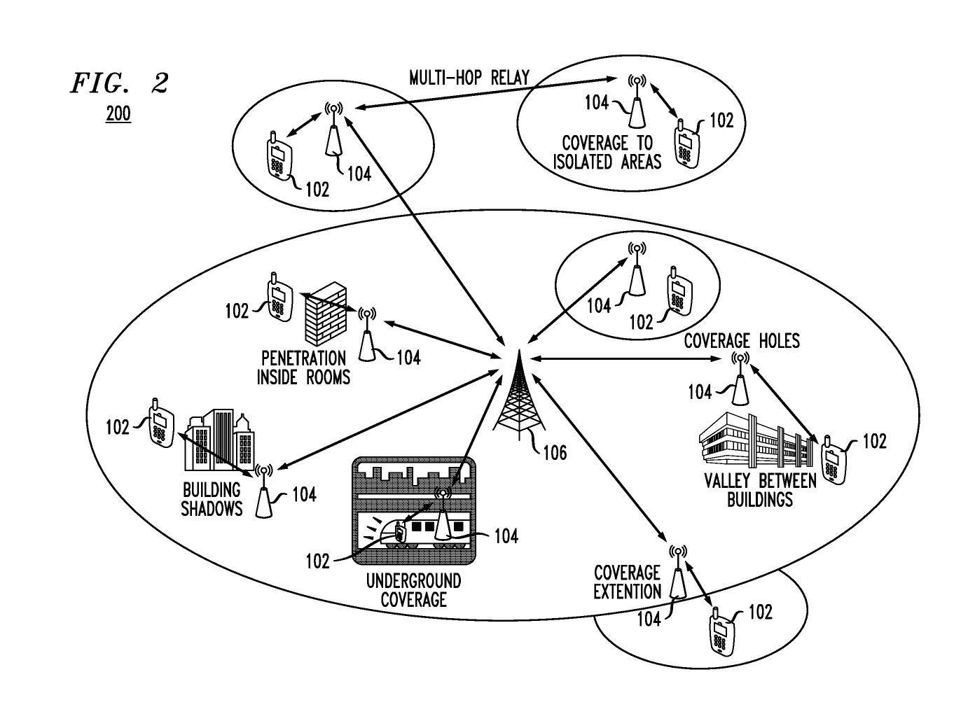

FIG. 2 depicts an E-UTRA network 200 according to an embodiment of the invention. The network 200 is similar to the network 100 of FIG. 1 as it comprises a plurality of UEs 102, a plurality of RNs 104, and an eNB 106. However, the network 200 depicts various examples of uses for relay nodes in a communication system such as an E-UTRA network. In general, relay nodes are used for one or more of coverage extension and bit rate throughput enhancement, both leading to improvement of end-user experience. Relaying use cases include but are not limited to: supporting urban hot spots; minimizing dead spots (e.g., coverage valleys, coverage holes, building shadows, room interiors, underground coverage, etc.); supporting indoor hot spots; supporting isolated areas (e.g., rural areas); providing temporary or emergency coverage; supporting wireless backhaul only; and supporting group mobility. Some of these use cases are illustrated in FIG. 2.

It is also to be appreciated that transmission associated with relay nodes may be single-hop or multi-hop. Single-hop is where the path from the operator's core network to the UE involves just a single RN. Muti-hop is where the path from the operator's core network to the UE involves more than one RN. Both scenarios are shown in FIG. 2.

Thus, benefits of the use of relay nodes include, for example, coverage extension and improvement of the system throughput and capacity. However, existing relay nodes have some general drawbacks. For example, existing relay nodes introduce complications in the overall system design and deployment. Existing relay nodes add to control/signaling overhead. Further, the additions of existing relay nodes to a non-relay node network are known to add undue complexity with respect to standards specifications.

Still further, the use of existing relay nodes are known to have security shortcomings. For example, in an existing E-UTRA network, an RN uses the User Plane (UP) as a backhaul for its Access Stratum/Non-Access Stratum Signaling Plane (SP), and thus existing RN traffic is unprotected.

Accordingly, illustrative principles of the invention provide an architecture for a relay node that comprises a hybrid configuration. In such hybrid configuration, the relay node functions as: (1) an eNB, in particular a Home eNodeB or HeNB, which has standardized IP/RP protection of its backhaul; and (2) as a data-oriented UE. It is to be appreciated that IP/RP protection in an HeNB is described in 3GPP TR 33.320, the disclosure of which is incorporated herein by reference in its entirety. The part of the relay node that has the HeNB functionality is referred to as the “RN eNB,” and the part of the relay node that has the data-oriented UE functionality is referred to as the “RN UE.” In one illustrative embodiment, the RN eNB and the RN UE modules of the RN are connected via an industry standard interface such as the IEEE 802.3 Ethernet. As will be evident, such improvements significantly reduce complexities related to integrity and replay protection of the backhaul traffic for relay nodes, and provide network operators with improved flexibility with respect to network deployment. For example, by decoupling access radio frequency (RF) technology from the backhaul RF technology, the inventive solution allows hybrid deployments with Evolved Packet System (EPS) access and EPS, WiMAX and HRPD (High Rate Packet Data) backhaul.

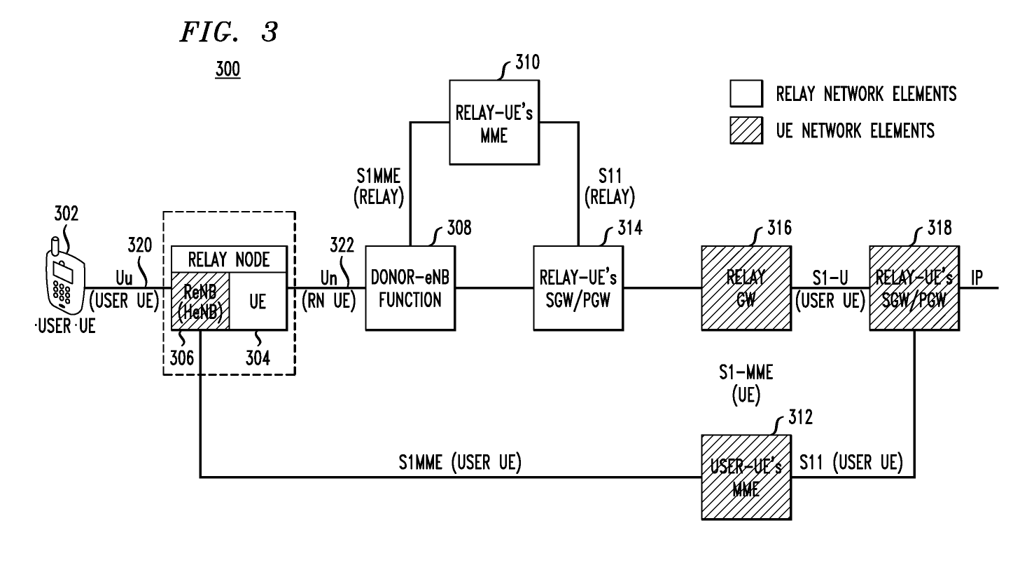

FIG. 3 illustrates functional network entities/elements associated with a hybrid relay node architecture 300 according to an embodiment of the invention. In FIG. 3, as shown, a Relay Node (RN) includes two main components: eNB (Relay Node eNB 306) and UE (Relay Node UE 304). User UE 302 is connected to the Relay Node eNB 306 but is agnostic whether connection is to a non-relay network component or Relay Node eNB. All of the Relay Node eNB backhaul traffic is being transported via the Un interface between Relay Node UE 304 and Donor eNB 308 network nodes. Such architecture allows flexibility of relay node deployment. The functional entities (in more detail) are as follows.

User UE 302: a typical user UE (i.e., any UE 102 in FIG. 1). Such user UE is assumed to be unaware of whether network access is via RN or directly with eNB.

RN UE 304: a UE which is an integral part of the RN. RN UE is connected through Donor eNB Function 308 to the network operator's access network. Examples of network operators may include, by way of example only, AT&T or Verizon.

RN eNB 306: an eNB which is an integral part of the RN. User UE 302 is attached to the network operator's access network through RN eNB 306.

RN MME 310: a Mobility Management Entity or MME which controls mobility/security for the RN through Donor eNB 308 to the RN UE 304).

User UE MME 312: an MME which controls mobility/security for the User UE 302 through RN eNB 306.

Relay UE SGW/PGW 314: a network attachment gateway for the Relay Node UE. It is similar in functionality to User UE SGW/PGW 318.

Relay Gateway 316: a network element responsible for security of the backhaul relay node traffic.

User UE SGW/PGW 318: a network attachment gateway for the User UE. It is similar in functionality to Relay UE SGW/PGW 314.

The SGW/PGW (Serving Gateway and PDN (packet data network) Gateway) routes and forwards user data packets. SGW is also acting as the mobility anchor for the user plane during inter-eNodeB handovers, while PGW is acting as the anchor for mobility between LTE and other 3GPP technologies. For idle state UEs, the SGW terminates the DL (downlink) data path and triggers paging when DL data arrives for the UE. The SWG manages and stores UE contexts, e.g., parameters of the IP bearer service, network internal routing information. The SWG also performs replication of the user traffic in case of lawful interception. PGW provides functionality such as packet filtering, IP address allocation, lawful interception, UL (uplink) and DL transport level packet marking, etc.

Interface Uu 320: typical EPS air interface.

Interface Un 322: an air interface between RN UE 304 and Donor eNB 308.

In one illustrative embodiment, RN eNB 306 is a network node to which User UE 302 is attached directly. Donor eNB 308 has RN UE 304 attached thereto, and the Un interface 322 is being used for transporting all of the backhaul traffic of the RN eNB 306.

One of the main security issues that arises here is that all RN eNB traffic (including its User Plane (UP) and Control Plane (CP) traffic) is being transported in the RN UE UP traffic.

However, per existing specifications, EPS UP traffic is not protected for replay and integrity (but may be confidentiality protected). The Non Access Stratum (NAS) component of the CP is end-to-end (User-UE to User MME) confidentiality, integrity, and replay protected. At the same time, the Access Stratum (AS) component of the CP is not required to be protected from RN eNB to RN MME. Such openness of the S1 RN MME over-the-air interface invites attacks.

Illustrative principles of the invention realize that confidentiality, integrity and replay protection for the entire backhaul RN eNB traffic can be implemented by deploying IPsec (Internet Protocol Security) in a tunnel mode between RN eNB and the security gateway in the operator's network. In this way, the RN eNB portion of the hybrid relay node can function similar to a Home eNB node (or Home NB in UTRAN, or more generally a H(e)NB, as explained below).

As is known, IPsec is a protocol suite for securing Internet Protocol (IP) communications by authenticating and encrypting each IP packet of a data stream. IPsec also includes protocols for establishing mutual authentication between agents at the beginning of the session and negotiation of cryptographic keys to be used during the session. IPsec can be used to protect data flows between a pair of hosts (e.g., computer users or servers), between a pair of security gateways (e.g., routers or firewalls), or between a security gateway and a host.

IPsec is a dual mode, end-to-end, security scheme operating at the Internet Layer of the Internet Protocol Suite or OSI model Layer 3. Some other Internet security systems in widespread use, such as Secure Sockets Layer (SSL), Transport Layer Security (TLS) and Secure Shell (SSH), operate in the upper layers of these models. Hence, IPsec can be used for protecting any application traffic across the Internet. Applications need not be specifically designed to use IPsec. The use of TLS/SSL, on the other hand, must typically be incorporated into the design of applications.

IPsec is defined by the Internet Engineering Task Force (IETF) in a series of Requests for Comment (RFCs) addressing various components and extensions. In particular, a security architecture for the Internet Protocol (IP) is defined in IETF RFC 4301, while RFC 4302, RFC 4303 and RFC 4306 define protocols used by IPsec to set up security associations, integrity protection, authentication, and confidentiality protection. The disclosure of each RFC is incorporated by reference herein in its entirety.

Accordingly, by using HeNB as an RN eNB, principles of the invention reduce standardization efforts and complexity, while solving the above-mentioned traffic protection problem.

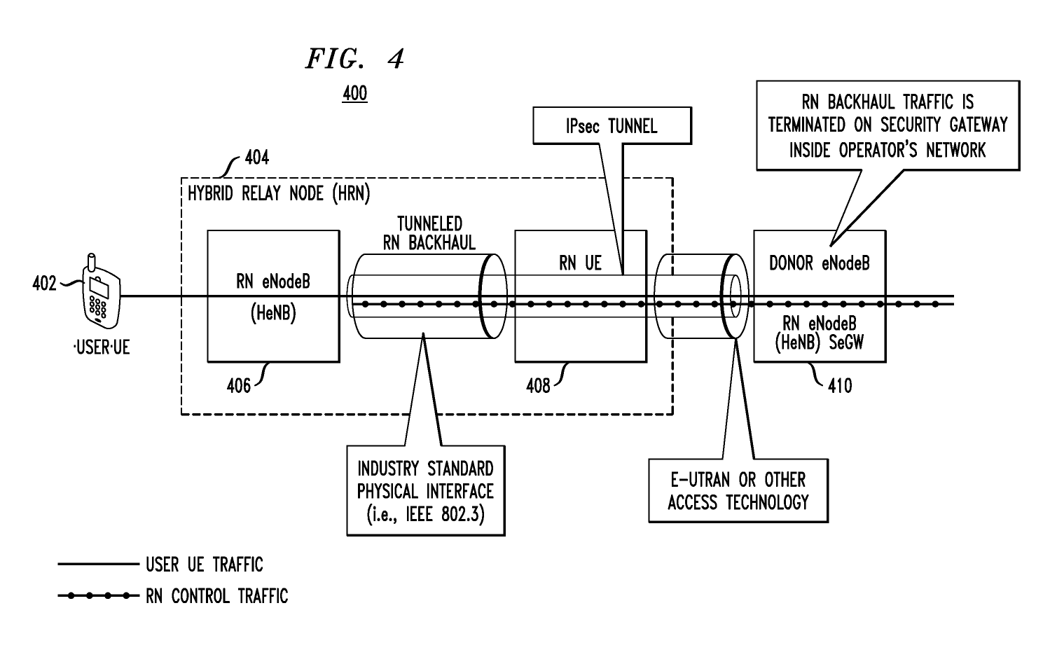

FIG. 4 illustrates protected traffic flow 400 associated with a hybrid relay node architecture according to an embodiment of the invention. Elements shown in FIG. 4 are similar to those described above and illustrated in the context of FIG. 3. Thus, FIG. 4 depicts a User UE 402, an RN 404 comprising an RN eNB 406 and an RN UE 408, and a Donor eNB 410. As shown, User UE traffic (both UP and CP components) is over-the-air protected by security association between User UE 402 and RN eNB 406. To the right of RN eNB 406, such traffic is being protected in the same IPsec tunnel together with RN eNB CP traffic. For the over-the-RN eNB—RN UE interface, RN eNB backhaul traffic is being transmitted inside the IPsec tunnel over an industry standard LAN (local area network) interface such as, for example, the IEEE 802.3 Ethernet standard, the disclosure of which is incorporated by reference herein in its entirety. From the RN UE 408 to the Donor eNB 410, RN eNB backhaul traffic is being transmitted inside the IPsec tunnel over E-UTRA (or other Radio Access technology). The IPsec tunnel protecting RN eNB backhaul traffic is terminated at the SeGW (security gateway) which is located either behind the Donor eNB or collocated with the Donor eNB.

Note that the RN backhaul traffic, as depicted in FIG. 4, may comprise one or more of User UE traffic (one or more data packets) and RN control traffic (one or more control packets). That is, by way of example only, one or more packets securely transferred over the RN backhaul may comprise packets associated with control functions between the RN and the core network, and they may comprise packets associated with multimedia communication associated with the end user UE (i.e., between two end users communicating across the core network of the network operator).

Note also that, in this illustrative architecture, RN eNB and RN UE may be on the same or different access technologies, ensuring additional deployment flexibility. That is, by decoupling the functions performed by the RN eNB and the RN UE, illustrative principles of the invention permit for the communication interface (Uu) between the User UE and the RN to be different than the communication interface (Un) between the RN and the Donor eNB. However, depending on the communication network in which the relay node is deployed, Uu and Un could be the same access technologies. Also, for clarity, RN UE-related network elements are omitted from FIG. 4.

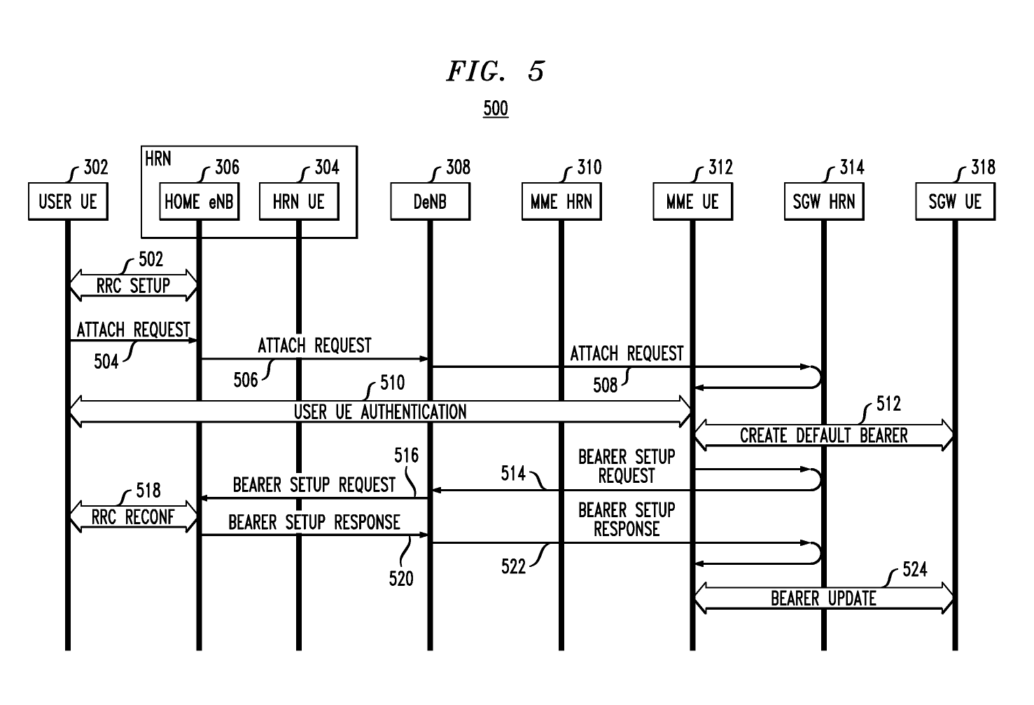

FIG. 5 illustrates a protocol 500 for an initial attach of a User UE connecting via an RN according to an embodiment of the invention. Note that in this figure, HRN refers to the hybrid RN of the invention. Also, the entities in the protocol 500 have the same reference numerals as described above and shown in FIG. 3. The protocol 500 proceeds as follows:

User UE completes RRC (Radio Resource Control) Setup procedure with the HRN (normal EPS procedure) (step 502); note that security aspects of the EPS Attach Procedure are specified in the TS 33.401, while security aspects of the UMTS Attach Procedure are specified in the TS 33.102, the disclosures of which are incorporated by reference herein in their entirety.

User UE sends Attach Request message to HRN (normal EPS procedure) (step 504).

HRN relays Attach Request to the Donor eNB (DeNB) (step 506).

DeNB forwards Attach Request through MME HRN and SGW HRN to the MME UE (step 508); note that this Attach Request is carried in the HRN UE UP traffic and goes through SGW HRN.

MME and User UE authenticate each other (normal EPS procedure) (step 510).

MME UE and SGW UE create default bearer (normal EPS procedure) (step 512).

MME UE sends Bearer Setup Request through SGW HRN (see note in step 508) to the DeNB (step 514).

DeNB relays Bearer Setup Request to HRN (step 516).

HRN and the User UE perform RRC RECONFIGURATION procedure (normal EPS procedure) (step 518).

HRN sends Bearer Setup Response to the DeNB (step 520).

DeNB relays Bearer Setup Response to the MME UE through SGW HRN (see note in the step 508) (step 522).

MME UE and SGW UE perform Bearer Update procedure (normal EPS procedure) (step 524).

Thus, the User UE is now connected to the network via the HRN, and all HRN backhaul traffic is protected in accordance with the illustrative principles of the invention described herein.

It is to be appreciated that uplink (UL) traffic may be transmitted from the core network to the User UE via the same channel (IPsec tunnel) or one or more other such channels may be established.

Also, it is to be understood that the illustrative principles of the invention described herein are equally applicable to a UTRA network, as well as other networks. In the case of a UTRA network (UTRAN), the terminology Home eNodeB (HeNB) changes to Home NodeB (HNB) and Donor eNodeB changes to Donor NodeB (note that the letter “e” is dropped). In fact, H(e)NB may be used to refer to either a E-UTRAN home base station node or a UTRAN home base station node. Thus, illustrative principles of the invention allow the use of UTRA as the User UE access technology simply by utilizing Home NodeB (HNB) as the RN NodeB.

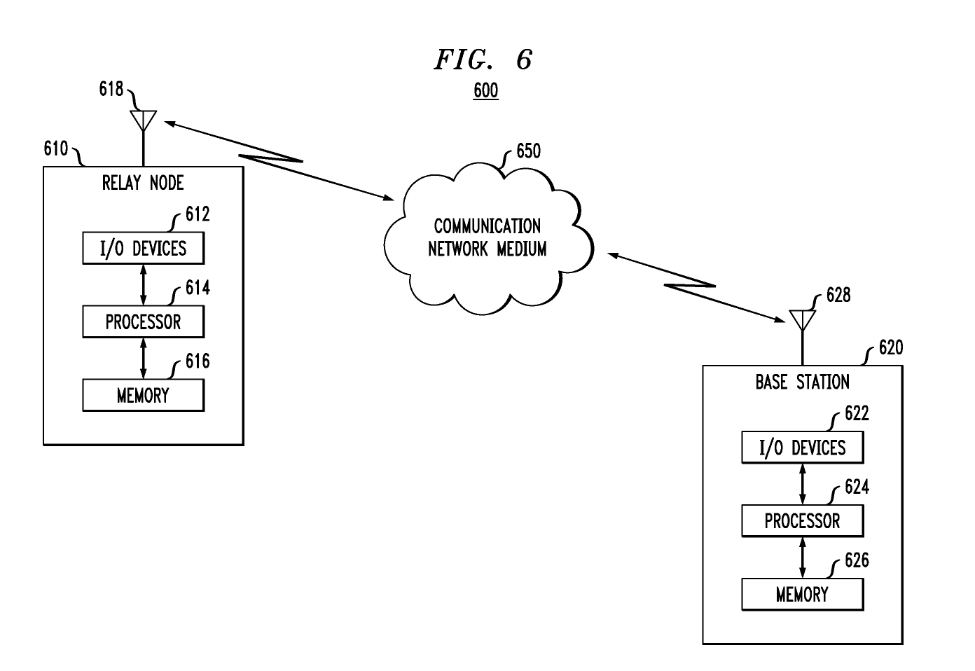

Lastly, FIG. 6 illustrates a generalized hardware architecture of a communication network 600 suitable for implementing protected relay node backhaul traffic according to the above-described principles of the invention.

As shown, relay node 610 (corresponding to RN 404) and base station 620 (corresponding to Donor eNB 410) are operatively coupled via communication network medium 650. The network medium may be any network medium across which the relay node and the base station are configured to communicate. By way of example, the network medium can carry IP packets and may involve any of the communication networks mentioned above. However, the invention is not limited to a particular type of network medium. Not expressly shown here, but understood to be operatively coupled to the relay node and/or the eNB, are the other network elements shown in FIGS. 3, 4 and 5 (which can have the same processor/memory configuration described below).

As would be readily apparent to one of ordinary skill in the art, the elements may be implemented as programmed computers operating under control of computer program code. The computer program code would be stored in a computer (or processor) readable storage medium (e.g., a memory) and the code would be executed by a processor of the computer. Given this disclosure of the invention, one skilled in the art could readily produce appropriate computer program code in order to implement the protocols described herein.

Nonetheless, FIG. 6 generally illustrates an exemplary architecture for each device communicating over the network medium. As shown, relay node 610 comprises I/O devices 612, processor 614, and memory 616. Reference numeral 618 is intended to represent the transmit/receive circuitry of the relay node. Base station 620 comprises I/O devices 622, processor 624, and memory 626. Reference numeral 628 is intended to represent the transmit/receive circuitry of the base station.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM). In addition, the term “I/O devices” as used herein is intended to include one or more input devices (e.g., keyboard, mouse) for inputting data to the processing unit, as well as one or more output devices (e.g., CRT display) for providing results associated with the processing unit.

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU. That is, each computing device (610 and 620) shown in FIG. 6 may be individually programmed to perform their respective steps of the protocols and functions depicted in FIGS. 1 through 5.

Also, it is to be understood that block 610 and block 620 may each be implemented via more than one discrete network node or computing device. For example, the RN eNB part (306 in FIG. 3) of the relay node 610 may be implemented in a network node or computing device physically and/or logically separate from a network node or computing device that is used to implement the RN UE part (304 in FIG. 3) of the relay node 610. However, in one alternative embodiment, the RN eNB component and the RN UE component may be collocated in one housing or single communication device such that it may be dynamically deployed into a communication environment (i.e., deployed in the field) to facilitate end user access to a core network.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method, comprising:
in a communication network wherein a first computing device comprises a user node, a second computing device comprises a relay node, and a third computing device comprises a network access node, and wherein the relay node comprises: a first module for connecting the user node to the communication network; and a second module for connecting the relay node to the network access node;
receiving at least one packet at the first module of the relay node from the user node over an interface established between the user node and the relay node;
sending at least one packet from the first module of the relay node to the second module of the relay node via a secure channel established by the first module in accordance with a secure communication protocol; and
sending the at least one packet from the second module of the relay node to the network access node via the secure channel and over an interface established between the relay node and the network access node.

2. The method of claim 1, wherein the at least one packet sent from the first module of the relay node comprises backhaul traffic.

3. The method of claim 2, wherein the backhaul traffic comprises at least one of: one or more data packets from the user node; and one or more control packets from the relay node.

4. The method of claim 1, wherein the first module of the relay node is coupled to the second module of the relay node via a local area network interface.

5. The method of claim 4, wherein the local area network interface comprises an Ethernet interface.

6. The method of claim 1, wherein the interface established between the user node and the relay node is a first wireless communication interface, and the interface established between the relay node and the network access node is a second wireless communication interface.

7. The method of claim 6, wherein the first wireless communication interface is different than the second wireless communication interface.

8. The method of claim 6, wherein the first wireless communication interface is the same as the second wireless communication interface.

9. The method of claim 1, wherein the communication network utilizes one of an Evolved UMTS Terrestrial Radio Access (E-UTRA) technology and a UMTS Terrestrial Radio Access (UTRA) technology.

10. The method of claim 9, wherein the user node is a UE node.

11. The method of claim 9, wherein the network access node is one of a Donor eNodeB node (E-UTRA) and a Donor NodeB (UTRA).

12. The method of claim 9, wherein the first module of the relay node is one of a Home eNodeB node (E-UTRA) and a Home NodeB (UTRA), and the second module of the relay node is a UE node.

13. The method of claim 1, wherein the secure channel established by the first module in accordance with the secure communication protocol comprise an Internet Protocol secure tunnel.

14. A relay node, comprising:
a first module for connecting a user node to a communication network; and
a second module for connecting the relay node to a network access node of the communication network;
wherein the relay node: receives at least one packet at the first module from the user node over an interface established between the user node and the relay node; sends at least one packet from the first module to the second module via a secure channel established by the first module in accordance with a secure communication protocol; and sends the at least one packet from the second module to the network access node via the secure channel and over an interface established between the relay node and the network access node.

15. The relay node of claim 14, wherein the at least one packet sent from the first module comprises backhaul traffic.

16. The relay node of claim 15, wherein the backhaul traffic comprises at least one of: one or more data packets from the user node; and one or more control packets from the relay node.

17. The relay node of claim 14, wherein the first module is coupled to the second module of the relay node via a local area network interface.

18. The relay node of claim 17, wherein the local area network interface comprises an Ethernet interface.

19. The relay node of claim 14, wherein the interface established between the user node and the relay node is a first wireless communication interface, and the interface established between the relay node and the network access node is a second wireless communication interface.

20. The relay node of claim 19, wherein the first wireless communication interface is different than the second wireless communication interface.

21. The relay node of claim 19, wherein the first wireless communication interface is the same as the second wireless communication interface.

22. The relay node of claim 14, wherein the communication network utilizes one of an Evolved UMTS Terrestrial Radio Access (E-UTRA) technology and a UMTS Terrestrial Radio Access (UTRA) technology, and the user node is a UE node, the network access node is one of a Donor eNodeB node (E-UTRA) and a Donor NodeB (UTRA), the first module is one of a Home eNodeB node (E-UTRA) and a Home NodeB (UTRA), and the second module of the relay node is a UE node.

23. The relay node of claim 14, wherein the secure channel established by the first module in accordance with the secure communication protocol comprise an Internet Protocol secure tunnel.

24. Apparatus, comprising:
a memory; and
at least one processor coupled to the memory and configured to form a relay node comprising a first module for connecting a user node to a communication network; and a second module for connecting the relay node to a network access node of the communication network, wherein the relay node: receives at least one packet at the first module from the user node over an interface established between the user node and the relay node; sends at least one packet from the first module to the second module via a secure channel established by the first module in accordance with a secure communication protocol; and sends the at least one packet from the second module to the network access node via the secure channel and over an interface established between the relay node and the network access node.

25. A method, comprising:
in a communication network wherein a first computing device comprises a user node, a second computing device comprises a relay node, and a third computing device comprises a network access node, and wherein the relay node comprises: a first module for connecting the user node to the communication network; and a second module for connecting the relay node to the network access node;
transmitting at least one packet between the first module of the relay node and the second module of the relay node via a secure channel established by the first module in accordance with a secure communication protocol; and
transmitting the at least one packet between the second module of the relay node and the network access node via the secure channel and over an interface established between the relay node and the network access node.
